(19) United States
(12) Patent Application Publication
(10) Pub. No.: US 2004/0024639 A1
(43) Pub. Date: Feb. 5, 2004

(54) Direct marketing management on behalf of subscribers and marketers

(76) Inventor: Phillip Y. Goldman, Los Altos, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/212,380

(22) Filed: Aug. 5, 2002

(51) Int. Cl. G06F 17/60

(52) U.S. Cl. 705/14; 705/26

(57) ABSTRACT

Systems and methods for managing direct marketing electronic messages between one or more marketers and one or more subscribers. The present invention generally relates to systems and methods for allowing subscribers to authorize transmission of direct marketing electronic messages from a group of marketers by either selecting particular marketers or completing a market survey. The present invention also relates to systems and methods for monitoring direct marketing electronic messages to ensure that the electronic messages conform to predetermined criteria. The present invention also relates to systems and methods for determining whether a particular direct marketing technique is effective or ineffective and responding appropriately to such determinations.

### BACKGROUND OF THE INVENTION

1. The Field of the Invention

The present invention relates generally to systems and methods for direct marketing. More specifically, the present invention relates to systems and methods for managing direct marketing on behalf of subscribers using electronic messaging.

2. Background and Relevant Art

Electronic messaging or e-mail has become, for many people, a primary means of communication. The ease by which a person is able to send and receive an electronic message makes this form of communication extremely attractive. Marketers have also utilized electronic messaging to reach consumers as most consumers check their electronic messages frequently. Unfortunately, an effective method of directing marketing toward consumers through electronic messaging does not yet exist.

One way marketers have attempted to reach consumers is through unsolicited bulk electronic messages, better known as “spam.” However, this method is overinclusive in that it contains many people who are not interested in the product and/or service of the marketer. Due to the influx of unsolicited electronic messages, people have become wary of giving out their electronic addresses for fear that their address will be sold to marketers. Furthermore, unsolicited electronic messages have come to be regarded as somewhat of an annoyance, much like junk mail. Those who send unsolicited electronic messages are subject to essentially no external restrictions on the frequency and content of their electronic messages. Thus, it has become common for users of e-mail to be subjected to frequent electronic messages that contain offensive or obscene content or information that is of little or no use to the recipient.

Another method marketers have used is to invite, through various means, consumers to sign up on electronic messaging lists. In this way, consumers have actually solicited electronic messages containing commercial advertisements or information. However, this method of soliciting is underinclusive in that it does not reach a potential audience of consumers that might be interested in the products and/or services the marketer has to offer.

Accordingly, it would be an advancement in the art to provide systems and methods for more effectively directing marketing toward consumers and enabling marketers and consumers to interact with each other in mutually beneficial exchanges of marketing information without the undesirable volume or content of unsolicited electronic messages that are currently common on the Internet.

### BRIEF SUMMARY OF THE INVENTION

In general, the present invention relates to systems and methods for managing direct marketing on behalf of subscribers. The present invention provides a direct marketing management application which manages the transmission of direct marketing electronic messages to be sent from one or more marketers to one or more subscribers. The present invention generally relates to systems and methods for allowing subscribers to authorize transmission of direct marketing electronic messages from a group of marketers. In one embodiment, the subscribers may select particular marketers from whom to receive direct marketing. In another embodiment, a market survey may be used to match up marketers with subscribers. The present invention also relates to systems and methods for monitoring direct marketing electronic messages to ensure that the electronic messages conform to predetermined criteria. The present invention also relates to systems and methods for determining whether a particular direct marketing technique is effective or ineffective and responding appropriately to such determinations.

The direct marketing management system of the invention mediates the interaction between marketers and consumers so that both parties involved in the exchange of marketing information are benefited. Moreover, the systems of the invention establish a marketplace for direct marketing that is accessible both to direct marketers and consumers. In general, the direct marketing management system can be closed or open from the standpoint of marketers. A closed direct marketing system is one in which a limited number of direct marketers are granted access to consumers, and the administrator of the direct marketing system manages access to consumers on behalf of the limited number of marketers. In contrast, an open direct marketing system is one in which substantially any direct marketer can participate, provided the direct marketer meets basic qualifications and abides by the restrictions and regulations imposed upon marketers by the administrator of the system. Under either system, consumers and direct marketers engage in mutually beneficial communication of marketing information in ways that reduce the volume of undesirable electronic messages and increase the likelihood of successful marketing by the marketers and the receipt of valuable marketing information by the consumers.

In order to implement this marketplace for direct marketing, a direct marketing management application can include the following modules, which can be used separately or together to manage direct marketing electronic messages: marketer management module, subscriber management module, electronic messaging processor, and statistics processor. The direct marketing management application interacts with the data storage device located on the marketer server. The data storage device stores such information relating to the direct marketing service of the present invention such as the marketer database, the subscriber database, and the statistics database.

Generally, a marketer registers to the direct marketing service of the present invention through the marketer management module. The marketer management module includes a registration module for providing an agreement, obtaining a marketing profile, obtaining direct marketing electronic messages from the marketer, and obtaining a marketing strategy from the marketer. The marketer management module includes a message monitoring module for monitoring the length, content, and times for transmitting the electronic message indicated by the marketer. The marketer management module also includes a termination module for monitoring when a particular direct marketing electronic message should no longer be sent to subscribers.

One or more subscribers may subscribe to the direct marketing service of the present invention through the subscriber management module. The subscriber management module provides a subscription module for providing an agreement, obtaining a market survey, and obtaining specific marketers from whom the subscriber wishes to receive direct marketing electronic messages.

The direct marketing management application includes an electronic messaging processor for sending direct marketing electronic messages to specified subscribers. Once a subscriber receives a direct marketing electronic message, statistics processor monitors the action that the subscriber takes upon the electronic message and determines whether the direct marketing electronic message is effective or ineffective. Based on these results, the statistics process may notify the marketer of the effectiveness of the direct marketing electronic message or may terminate transmission of that electronic message altogether.

The marketer server may serve as a gateway for all direct marketing electronic messages delivered to subscribers of the direct marketing service of the present invention. In another embodiment, marketer server may serve as a facilitator to authorize one or more marketer to send direct marketing electronic messages directly to one or more subscribers.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram illustrating a generalized network through which a direct marketing electronic message is transmitted from a marketer to a subscriber.

FIG. 2 is a block diagram illustrating functional components of the direct marketing management application of the present invention.

FIG. 3 is a block diagram illustrating functional components of the marketer interface module.

FIG. 4 is a block diagram illustrating functional components of the subscriber interface module.

FIG. 5 is a block diagram illustrating functional components of the electronic messaging processor.

FIG. 6 is a block diagram illustrating functional components of the statistics processor.

FIG. 7 is a block diagram illustrates a data structure for a marketer database.

FIG. 8 is a block diagram illustrating a data structure for a subscriber database.

FIG. 9 is a block diagram illustrating a data structure for a statistical database.

FIG. 10 illustrates a system for implementing the direct marketing management application of the present invention.

FIG. 11 illustrates an alternative system for implementing the direct marketing management application of the present invention.

FIG. 12 illustrates a system for implementing the direct marketing management application of the invention as well as a system for reducing or eliminating unwanted electronic messages.

FIG. 13 illustrates an exemplary processing system that can be used to implement the invention.

### DETAILED DESCRIPTION OF THE PREFERRED EMBODIMENTS

The present invention extends to both methods and systems for management of direct marketing to effectively market products and/or services of the marketer. As used in the specification, the term “marketer” indicates any entity which wishes to implement direct marketing as a means for publicizing, commercializing, or notifying the public of a product, service, or other aspect of the marketer. Thus, a marketer does not necessarily have to be a for-profit entity but includes any non-profit or for-profit entity.

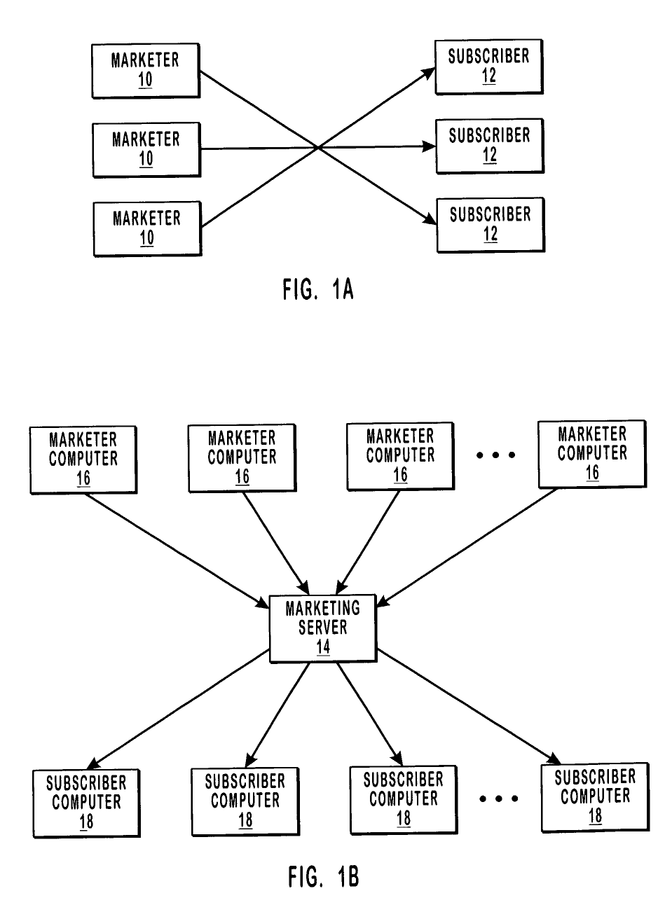

In generalized terms, as shown in FIG. 1A, the present invention is directed toward managing direct marketing of a group of marketers 10 to a group of subscribers 12. The term “direct marketing” as used in this specification refers to sending electronic messages to a group of subscribers who have indicated a desire to receive communications from a group of marketers. Direct marketing may also include a subscriber requesting communications from a particular marketer or information relating products or services having specified characteristics.

In order to prevent the direct marketing electronic messages of the present invention from taking on aspects of unsolicited electronic messages (or spam), the present invention implements features which target specific audiences rather than sending bulk electronic messages to unconsenting individuals. Of significant note is the fact that the recipients of the direct marketing electronic messages of the present invention have consented to some level of direct marketing. Hence, the term “subscriber” as used in this specification indicates a person or entity which has consented to some level of direct marketing. In order to be a subscriber, the person or entity does not have to specifically request direct marketing from a specific marketer. The term “consumer” as used herein generally refers to subscribers and highlights the relationship between the subscribers and the marketers who participate in the marketplace for direct marketing that can be established according to the invention.

The term “electronic messaging” includes any form of sending a message electronically including, but not limited to, e-mail, instant messaging, broadcasted messages in a computer network, or other mechanisms for transporting information between marketers and consumers. For sake of simplicity, the following description of direct marketing electronic messaging refers to context of e-mail transmitted between computers using the Internet, but is generally applicable to these other transport mechanisms.

FIG. 1B depicts a generalized network through which direct marketing between a marketer 10 and a subscriber 12 may take place. As shown in FIG. 1B, a marketing server 14 is located between one or more marketer computers 16 and one or more subscriber computers 18. Marketer computers 16 are representative of marketers 10 and subscriber computers 18 are representative of subscribers 12. As depicted in FIG. 1B, the direction of the arrows indicates the path of a direct marketing electronic message prepared by the marketers 10 and sent to the subscribers 12.

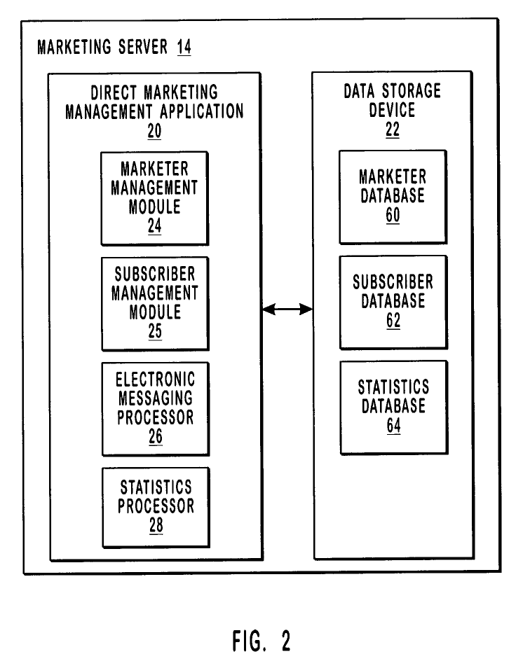

As shown in FIG. 2, an inventive direct marketing management application 20 incorporating features of the invention is implemented on marketer server 14. Marketer server 14 has a data storage device 22 which interacts with direct marketing management application 20. The direct marketing management application 20 can be implemented in any of a variety of ways that will be understood by those of skill in the art upon learning of the invention disclosed herein. For example, much of the direct marketing management application 20 can be implemented and caused to perform methods of the invention using commands and functionality that are natively supported by some existing electronic messaging processors. Alternatively, direct marketing management application 20 can be a functional component written in computer-executable code that is separate from the electronic messaging processor and that interfaces with the electronic messaging processor.

I. Direct Marketing Management Application

In general, the systems of the invention establish a mutually beneficial marketplace for direct marketing and significantly reduce many of the problems that have been associated with conventional direct marketing using electronic messaging, which has been characterized by a lack of restrictions imposed on marketers and a large volume of undesirable and useless information received by consumers from direct marketers. According to the invention, access to consumers is regulated, in that the content and frequency by which direct marketers contact consumers is limited or restricted. Moreover, in one embodiment of the invention, as will be described in greater detail below, the consumers are anonymous from the standpoint of the direct marketers, at least initially and as long as is desired by the consumers.

The marketplace for direct marketing established according to the invention can exist according to either of two basic models, including a closed system and an open system. In the closed system, the administrator of the direct marketing management system of the invention provides only a limited number of direct marketers with access to consumers. The closed system may impose overall limits on the number of direct marketers who participate in any way, limits on the number of direct marketers that offer certain categories of goods or services (e.g., a limited number of mortgage lenders or digital camera vendors), or limits on the number of marketers who can access individual subscribers. In contrast, in the open system, an indefinite number of direct marketers can gain access to consumers, provided that the direct marketers qualify under specified criteria and conduct marketing campaigns that are regulated by the administrator of the system or automated rules. In either case, the direct marketers can increase the likelihood that the recipients of their marketing information will be interested and will respond favorably thereto. Likewise, under either system, consumers can control the frequency and content of the direct marketing electronic messages that they receive and can maintain anonymity with respect to the marketers.

In order to achieve these results, the direct marketing management application 20 provides functional components that manage the criteria for sending a direct marketing electronic message from a marketer 10 to a subscriber 12. Direct marketing management application 20 comprises a marketer interface module 24, subscriber interface module 25, an electronic messaging processor 26, and a statistics processor 28. Each of these components is described as follows.

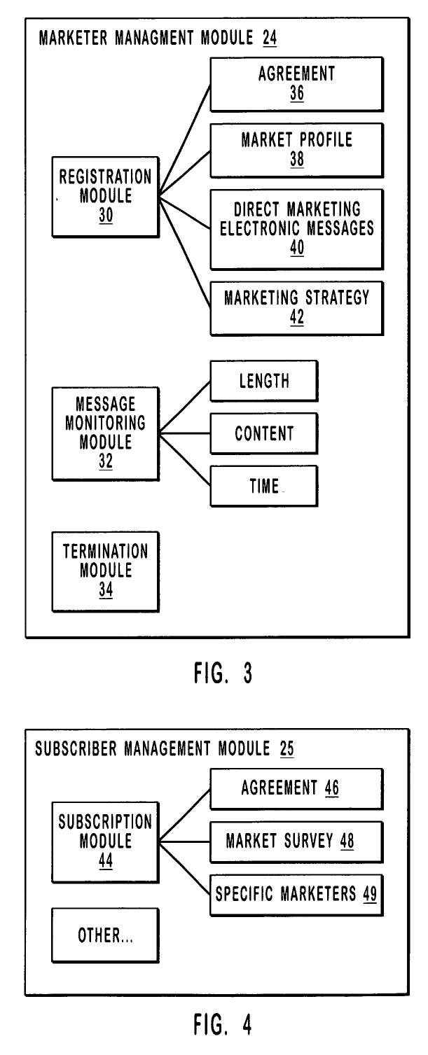

Marketer interface module 24, shown in FIGS. 2 and 3, comprises a registration module 30, a message monitoring module 32, and a termination module 34. When marketer 10 desires to send direct messages to subscriber 12, marketer 10 first registers to direct marketing management application 20 through registration module 30. Registration module 30 includes an agreement 36 which discloses the terms by which marketer 10 agrees to participate. Such terms may include that marketer 10 will maintain the length of direct marketing electronic messages to a predetermined limit, that marketer 10 will send direct marketing electronic messages only during specified periods of time, that marketer 10 will not send any obscene, lewd, or offensive direct marketing electronic messages, as well as agreement to pay any particular fee for using the direct marketing service of the present invention.

In general, the marketer 10, in order to fulfill the requirements for registration, is required to agree to restrictions that decrease the likelihood that subscribers will receive unwanted electronic messages or will otherwise have a negative experience with the direct marketing information. In exchange for agreeing to the restrictions imposed on its direct marketing activity, the marketer 10 gains access to subscribers who are more likely to be willing participants in the exchange of marketing information. In this way, the marketers and subscribers participate in a mutually beneficial marketplace for direct marketing activity.

In closed direct marketing management systems, in which the number of direct marketers is limited, the process of registration by marketers may be less frequent and may be less automated than the process in open systems. For instance, in closed systems, it may be the case that some or all of the marketers are registered initially and are based on “offline” criteria, and no newcomers are permitted to register. In contrast, in open systems, the process of registration can be ongoing and lends itself to automation to permit new direct marketers to easily become affiliated with the direct marketing management systems of the invention.

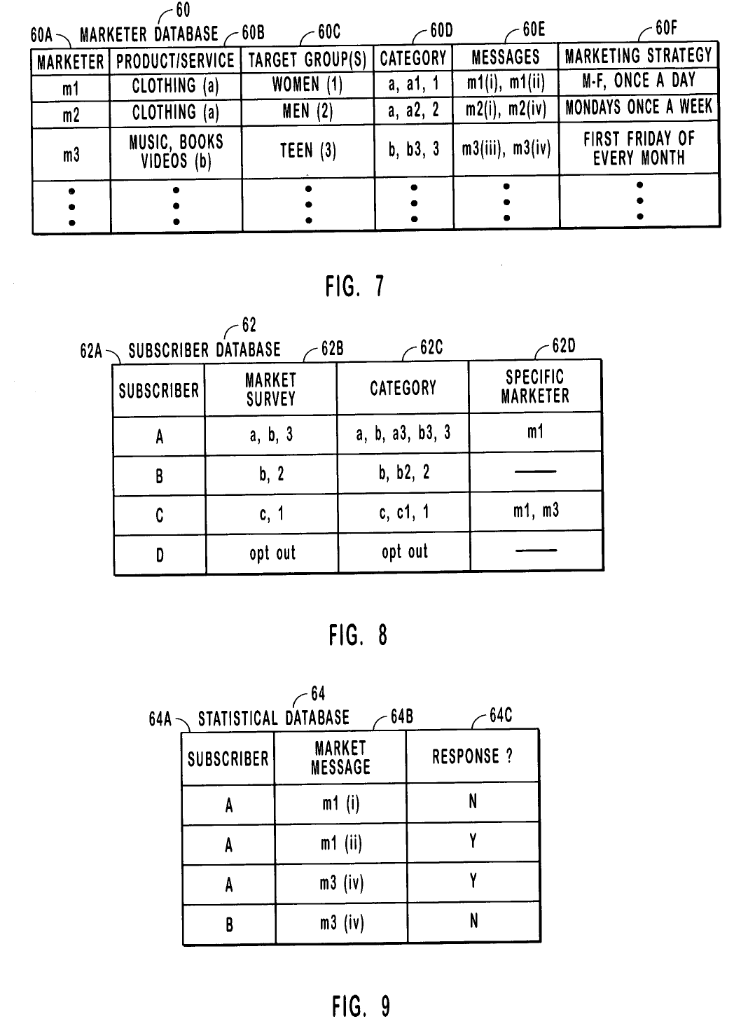

If the marketer 10 assents to agreement 36, registration module 30 obtains a marketing profile 38 from marketer 10. Marketing profile 38 includes requests for the products/services that marketer 10 offers, preferred target demographics such as, but not limited to, age, sex, household income, hobbies, interests, sports, music, geographic location, and the like. Registration module 30 then performs an analysis of market profile 38 and assigns marketer 10 to a number of different marketing categories accordingly. It will be appreciated that a variety of ways exist to analyze market profile. For example, as shown in FIG. 7, for a market profile containing the product/service and a general target group, categories can be identified by assigning an identification number to all possible combinations of categories. Marketer 10 may amend marketing profile 38 at any time according to changes in services or desire to target different groups.

Registration module 30 allows marketer 10 to prepare or transmit already prepared direct marketing electronic messages 40. Marketer 10 may amend previously submitted direct marketing electronic messages, delete previously submitted direct marketing electronic messages, or add new direct marketing electronic messages. Marketer 10 may include hyperlinks in any direct marketing electronic message so that, upon receipt, the subscriber may directly link to a website. Hyperlinks may also be used to form marketing statistics as will be described below in further detail.

Registration module 30 allows for marketer 10 to input a marketing strategy 42. The marketer's 10 marketing strategy 42 may indicate the date, time, frequency, and marketing category of the direct marketing electronic message to be sent to subscribers subject to predetermined criteria as discussed in agreement 36. Marketer 10 may specify a marketing strategy 42 for each direct marketing electronic message it submits/prepares. Alternatively, marketer 10 may form the same marketing strategy 42 for all of its direct marketing electronic messages.

Message monitoring module 32 evaluates each direct marketing electronic message sent by marketer 10 or a sample thereof to ensure that the electronic message satisfies certain predetermined criteria. Such criteria may include a limit on the length of the message, a limit on the content of the message, and a limit on the time, date, or frequency that the message is sent. If any of these criteria is not met, the system sends a notification to marketer 10 to amend or submit a new direct marketing electronic message and/or marketing strategy meeting the predetermined criteria.

The termination module 34 determines the future marketing privileges of marketer 10 and when the marketer should be prohibited from sending direct marketing electronic messages either based on actions by the marketer or circumstances beyond the marketer's control. Marketer 10 can be prohibited from participating in the present system if marketer 10 does not comply with the terms of agreement 36 as determined by message monitoring module 32. Of course, if marketer 10 fails to pay the associated fee, marketer 10 may also be prohibited from accessing/using the system. Alternatively, statistics processor 28 may determine that the direct marketing electronic messages are not effective and may cease transmitting the ineffective electronic messages. This latter situation will be described in more detail with respect to statistics processor 28.

Termination module 34 can operate by compiling a rating or another metric that evaluates the marketing activity of particular marketers and recommending or automatically taking action in response to the rating. For instance, if it has been determined that the rating of a particular marketer has fallen below a first threshold based on, for example, marketing activity that exceeds the permissible frequency, the marketer may be placed on probation with a manual review process of the marketing activity. Alternatively, in response to the rating falling to the first threshold or in response to the rating falling to a lower second threshold, the marketing privileges of the marketer can be suspended.

The rating can be based on substantially any information that characterizes the activity of a marketer. As described herein, if the marketer has engaged in a marketing campaign that has been ineffective to the point of resembling “spam”, the rating of the marketer can be adversely affected. Examples of information on which ratings can be based include numerical ratings or other feedback from subscribers, complaints from subscribers, requests from subscribers to no longer receive marketing information from the marketer, the amount of subscriber actions in response to receiving electronic messages from the marketer, compliance with marketing budgets regulating the number of electronic messages that can be sent, etc.

Another related technique for enhancing the overall effectiveness of marketing campaigns and reducing the volume of unwanted electronic messages is to require new marketing campaigns to be initiated or rolled out incrementally. For instance, a new marketing campaign proposed by a marketer who participates in a direct marketing management system of the invention may be required to initially send electronic messages associated with its campaign to a relatively small number of subscribers. Based on the effectiveness of the initial phase of the campaign determined, for example, using the ratings described herein, the marketer may or may not be permitted to increase the volume of electronic messages sent as part of the campaign. In this manner, the likelihood that a particularly unsuccessful or unpopular marketing campaign being presented to large numbers of subscribers is reduced.

Subscriber interface module 25, illustrated in FIGS. 2 and 4, interacts with subscribers 12. Subscriber interface module 25 comprises a subscription module 44. When a subscriber 12 wishes to participate in the direct marketing system of the present invention, the subscriber 12 subscribes through subscription module 44. Subscription module 44 includes an agreement 46 which sets forth the terms of participation, and can take the form of a legally binding contract between the subscriber and the entity that administers the direct marketing management system of the invention. Such terms may include that subscriber 12 agrees to accept some form of direct marketing, subscriber 12 agrees to be monitored as far as whether the subscriber opens and/or acts upon direct marketing electronic messages, as well as agreement to pay or receive a fee in association with the direct marketing service of the present invention.

If subscriber 12 assents to agreement 46, subscription module 44 obtains a market survey 48 from subscriber 12. Market survey 48 includes requests for demographics such as, but not limited to, age, sex, household income, hobbies, interests, sports, music, geographic location, and the like. Market survey 48 may also provide subscriber 12 with a list of the specific marketers 10 participating in the direct marketing service of the present invention and allow subscriber 12 to specify one or more marketers 10 from which to receive direct marketing. Subscription module 44 then assigns subscriber 12 to a number of different marketing categories (similar to those for the marketing profile for marketers 10) based on market survey 48. Subscriber 12 may amend market survey 48 at any time according to changes in demographics and/or interests. This information is stored and is incorporated into a profile of the subscriber, which is used to effectively target direct marketing electronic messages to the subscriber. The profile can be associated with a name or other identifying information or can be associated with a user ID that maintains the anonymity of the subscriber.

Electronic messaging processor 26, shown in FIGS. 2 and 5, may be a conventional electronic messaging processor which controls the incoming and outgoing electronic messages for a plurality of subscriber computers. Alternatively, electronic messaging processor 26 may be an electronic messaging processor software program assembled and adapted specifically for use with the direct marketing methods described herein. Generally, electronic messaging processor 26 comprises a retrieval module 50 which retrieves direct marketing electronic messages that are submitted by marketers 10 and stored on data storage device 22. In addition, electronic messaging processor 26 comprises a transmission module 52 that sends the retrieved direct marketing electronic messages at times specified by the marketing strategy 42 for that particular electronic message.

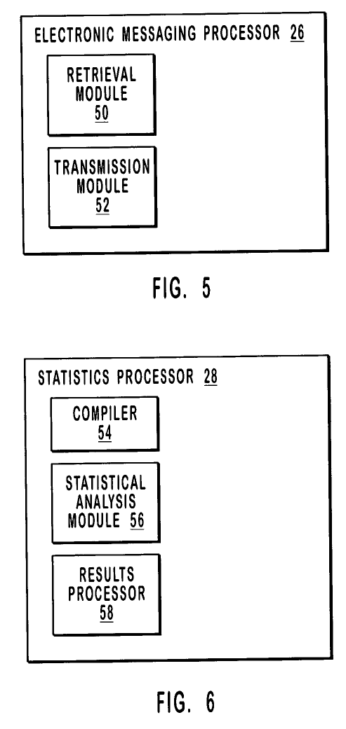

Statistics processor 28, shown in FIGS. 2 and 6, determines whether a particular direct marketing electronic message is effective or ineffective. The criteria and action taken for an effective or ineffective direct marketing electronic message are generally set forth in agreement 36. However, in another implementation, marketer 10 can determine the criteria for an effective/ineffective direct marketing electronic message. Statistics processor 28 comprises a compiler 54, an analysis module 56 and a results processor 58.

Compiler 54 tracks the direct marketing electronic messages that are sent to subscribers 12 and determines whether the subscriber 12 has performed an action in response to receiving the direct marketing electronic message. The action can be opening the electronic message, saving the message, forwarding or replying to the message, making a purchase in response to receiving the message, requesting further information, engaging in activity associated with the content of the electronic message on the Internet, or any other such action that indicates that the subscriber has expressed at least some interest in the content of the electronic message. As mentioned above, a direct marketing electronic message may contain a hyperlink to a web site of marketer 10. In one embodiment, the hyperlink is routed through marketing server 14 so that compiler 54 is notified when a hyperlink is activated. This may include marketing server 14 hosting a web page for marketer 10 and then linking to marketer's 10 web site that may be hosted on a remote server. In another embodiment, a compiler 54 is downloaded to the subscriber computer 18 as part of agreement 46. When located on subscriber computer 18, compiler 54 is able to track when a direct marketing electronic message from marketing server 14 has been opened. Compiler 54 then transmits this information to be stored on marketing server 14.

Analysis module 56 accesses the stored information that compiler 54 gathers. Analysis module 56 comprises one or more statistical analysis algorithms that are used to determine whether a particular direct marketing electronic message is effective or ineffective. While details of statistical algorithms may vary, generally, a direct marketing electronic message which is not opened or acted upon will be determined ineffective. A determination that a direct marketing electronic message is ineffective means that subscriber 12 consider the direct marketing electronic message similar to unsolicited electronic messages. Alternatively, a direct marketing electronic message which is frequently opened or acted upon by a subscriber 12 will be determined as an effective direct marketing tool. Analysis module 56 may also determine the effectiveness/ineffectiveness of a particular direct marketing electronic message in terms of degrees. For example, a direct marketing electronic message may be determined to be highly effective, moderately effective, moderately ineffective, or highly ineffective. The frequency of the analysis of whether a direct marketing electronic message is effective/ineffective can vary. In one embodiment, statistical analysis may occur on a daily or weekly basis, for example. In another embodiment, statistical analysis may occur whenever a batch of direct marketing electronic messages are sent.

Results processor 58 further acts upon the determination made by analysis module 56 that a particular direct marketing electronic message is effective or ineffective. If a direct marketing electronic message is ineffective for a period of days or weeks, results processor 58 transmits reports including this information to marketer 10. Pursuant to agreement 36, results processor 58 may also discontinue transmittal of the particular direct marketing electronic message based upon the degree to which the direct marketing electronic message is evaluated as ineffective. If a direct marketing electronic message is effective, results processor 58 may transmit this information to marketer 10. If a direct marketing electronic message is particularly effective, results processor 58 may suggest to marketer 10 to broaden the marketing profile 38 or marketing strategy 42 for that particular direct marketing electronic message. Alternatively, a particularly effective direct marketing electronic message can be automatically selected for additional use in a marketing campaign based on its effectiveness.

In general, reports provided to marketers can verify that a specified number of marketing electronic messages have been delivered to subscribers and can report on the effectiveness of the marketing campaign. Such reports are particularly important when the anonymity of the subscribers is maintained and a marketing server associated with the direct marketing management system transmits the electronic messages to the subscribers on behalf of the marketers. Such reports enable the marketer to judge the effectiveness of a campaign and to prepare strategies for future campaigns.

Similarly, information associated with marketers can be provided to individual subscribers. For instance, if a subscriber has changes his profile such that a certain marketer is likely to send the subscriber marketing information, the subscriber can be presented with information explaining the effectiveness of the marketer's campaigns and other information, such as numerical ratings generated by other subscribers. This information can permit the subscriber to know what to expect from the marketer and to decide whether to opt out of receiving marketing information from the marketer.

II. Data Storage Device

Data storage device 22 maintains information regarding marketers, subscribers and statistics in order to carry out the functions of the direct marketing management application 20. Data storage device 22 comprises a marketer database 60, a subscriber database 62, and a statistical analysis database 64. It will be appreciated that the foregoing databases are representative of the types of information that may be gathered by direct marketing management application 20 and are not to be considered limiting in any way.

As shown in FIG. 7, marketer database 60 comprises categories relating to requests made in marketer management module 24. From left to right, marketer column 60A identifies the particular marketer 10. Marketer 10 may be identified by name, e-mail address, web site address, and the like. Product/service column 60B and target group(s) column 60C contain information from marketing profile 38. For example, in FIG. 7, product/service column 60B shows the product/service that is offered by marketer 10, including information that is collected from external or third-party sources. Target group(s) column 60C shows the target group(s) to which marketer 10 desires to target its marketing. Category column 60D stores the categories in which registration module 30 classifies marketer 10. Messages column 60E stores the various direct marketing electronic messages submitted by marketer 10. In this embodiment, each direct marketing electronic message is identified by the marketer and a sequential identification number. Marketing strategy column 60F indicates the marketing strategy for a particular direct marketing electronic message. Alternatively, for some marketers 10, the same marketing strategy may be used for all direct marketing electronic messages for that marketer.

Turning to FIG. 8, subscriber database 62 comprises categories relating to requests made in subscriber management module 26. From left to right, subscriber column 62A represents or identifies the particular subscriber 12. In order to maintain anonymity of the subscriber 12, the subscriber can be represented only by a user ID that does not include information that discloses the personal identity of the subscriber. In general, the information in the subscriber database can be substantially anonymous so long as sufficient information exists to enable the entity that administers the direct marketing management system to deliver electronic messages to the subscriber. Alternatively, subscriber 12 may be identified by name, e-mail address, home address and phone number, and the like, although this type of identification can decrease the anonymity of subscribers.

In general, the subscriber database includes profile information relating to the subscribers. For instance, market survey column 62B indicates the results from the market survey 48 obtained by subscriber module 44. Category column 62C indicates the categories in which subscriber module 44 classifies subscriber 12. Specific marketer column 62D indicates any specific marketers from whom subscriber 12 wishes to receive direct marketing. In one embodiment, subscriber 12 may be given the option to “opt out” of receiving direct marketing electronic messages from particular marketers or for particular products or services. In addition, subscribers can be permitted to edit or revise their profiles so as to further specify their interests, demographic information, or the types of direct marketing information that is or is not desired.

Maintaining information classifying or categorizing subscribers is important in that the direct marketers are able to target subscribers who are relatively likely to be receptive to a particular direct marketing campaign. Likewise, subscribers benefit from accurate categorization of their interests and demographic information, since subscribers generally have an interest in receiving marketing information that is likely to be useful and in not receiving marketing information relating to services or products that do not coincide with the subscribers purchasing patterns or interests. Thus, accurate profile information enhances the effectiveness of the marketplace for direct marketing for both the marketers and the subscribers.

As noted above, the demographic information included in the profile can extend to geographic information represented, for example, by postal codes or telephone area codes and/or prefixes. Such information can identify the geographic location of the subscribers, such that direct marketing information for local marketers (e.g., local automobile dealerships, restaurants, etc.) can be provided to the subscribers. Categorization of the subscribers based on geographic information or other demographic information can further enhance the marketplace for marketing information that is established according to the invention by enabling subscribers to receive marketing information that is geographically relevant or is relevant in other ways.

FIG. 9 depicts statistical database 64 as created by compiler 54 in statistics processor 28. It will be appreciated that data relating to a particular direct marketing electronic message may be compiled by direct marketing electronic message or by subscriber, as well as any other criteria. In the embodiment shown in FIG. 9, the information is collected based on the subscriber. From left to right, subscriber column 64A identifies the particular subscriber to which a direct marketing electronic message is sent. Market message column 64B indicates the identification number of the direct marketing electronic message sent. Response column 64C indicates whether the subscriber opened, acted upon, or otherwise responded to the direct marketing electronic message.

III. Direct Marketing Application Architecture

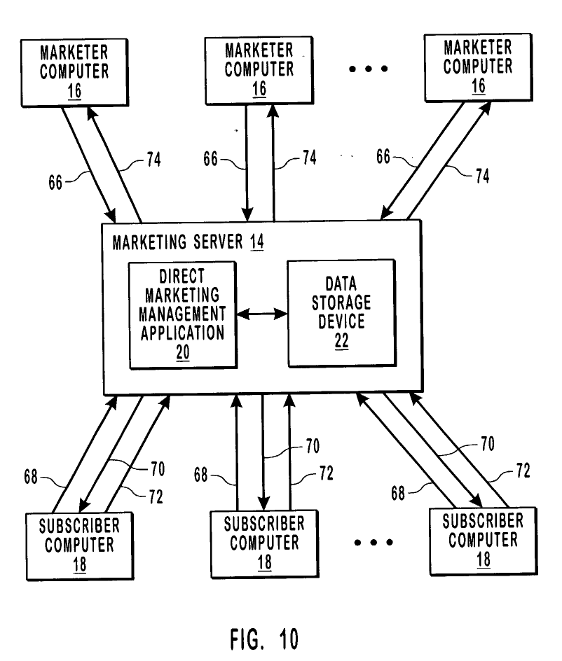

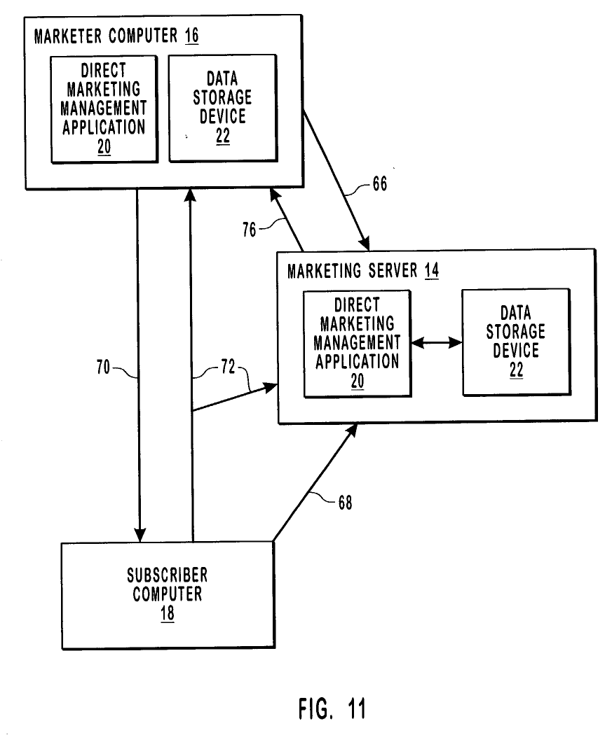

FIGS. 10 and 11 depict embodiments of architecture that may be applicable to the direct marketing service of the present invention. It will be understood that the embodiments in FIGS. 10 and 11 are presented by way of illustration and not by limitation. FIGS. 10 and 11 both relate to the process by which direct marketing electronic messages are delivered from marketers to subscribers. In either embodiment, it is desirable to maintain the anonymity of subscribers from the standpoint of the marketers until such time that a subscriber decides to disclose his identity to a marketer. In this manner, the entity that administers the direct marketing management system of the invention can regulate the frequency and content of the marketers' electronic messages that are sent to subscribers.

FIG. 10 depicts one embodiment wherein all transactions are executed by and/or through marketing server 14. Similar to that shown in FIG. 1B, marketing server 14 connects a plurality of marketer computers 16 to a plurality of subscriber computers 18. As represented at 66, marketers 10 register to the direct marketing management application 20 located on marketing server 14. As represented at 68, subscribers 12 subscribe to the direct marketing management application 20. Direct marketing management application 20 then assesses which direct marketing electronic messages should be sent to which subscribers 12 or which direct marketing electronic messages should not be sent to particular subscribers 12. As represented at 70, electronic messaging processor 26 sends direct marketing electronic messages to subscribers 12. The subscribers 12 may or may not act upon receipt of a particular direct marketing electronic message. Such marketing statistics are transmitted to direct marketing management application 20 as represented at 72 and evaluated by statistics processor 28. Finally, results from the statistical analysis are transmitted to marketer 10 as represented at 74.

In the embodiment of FIG. 10, in which all electronic messages from marketers 10 are processed by or through marketing server 14, the task of maintaining the anonymity of the subscribers 12 from the standpoint of the marketers is relatively simple. The distribution of marketing information according to this model is comparable to the process of advertising in broadcast media such as radio or television in that the communication is one-way and anonymous unless the consumer chooses to make his identity known to the marketer. Unlike conventional broadcast media, however, the distribution of marketing information according to the invention is targeted to subscribers who are more likely than a member of the general population to be interested in the content of the marketing information.

In order to further maintain anonymity of the subscribers 12, the subscribers can be alerted when they are engaging in an action that will disclose their identity to a marketer 10. For instance, when a subscriber 12 is about to transmit an electronic message to a marketer 10 in response to the direct marketing electronic message, the subscriber can be alerted to the fact that this action may disclose the subscriber's identity to the marketer. Unregulated two-way communication between a subscriber 12 and a marketer 10 outside of the communication channels associated with the marketing server 14 can often eliminate the anonymity of the subscriber. In order to enable the subscriber to communicate with the marketer while preserving anonymity, the marketing server 14 can take certain actions to protect the subscriber. For instance, any communication from the subscriber 12 to the marketer 10 can also pass through marketing server 14, preserving anonymity. Alternatively, the subscriber can be given a single-use or ad hoc e-mail address that is to be used for a single session of communication with a particular marketer. Or, the user can be alerted or prompted for permission to break anonymity. In this way, the subscriber 12 can maintain full anonymity with respect to the marketers 10, and the direct marketing management system of the invention can regulate the manner in which marketers communicate with the subscribers.

In an alternative embodiment shown in FIG. 11, marketing server 14 still connects marketer computers 16 to a plurality of subscriber computers 18. However, much of the processes of direct marketing management application 20 may occur outside of marketer server 14. Generally, as represented at 66, marketer 10 registers to the direct marketing management application 20 located on marketer server 14. As represented at 68, subscribers 12 subscribe to direct marketing management application 20. At 76, marketer computer 16 can then download aspects/features of direct marketing management application 20. At that point, marketer 10 may also obtain permission to send direct marketing electronic messages to various subscribers 12. As represented at 70, marketer 10 sends direct marketing electronic messages directly to subscriber 12 from marketer computer 16. As represented at 72, subscriber computer 18 returns marketing statistics to marketer computer 16. Optionally, subscriber computer 18 may also send the same marketing statistics to marketer server 14 so that marketer server 14 may independently monitor the effectiveness of the marketer's direct marketing electronic messages.

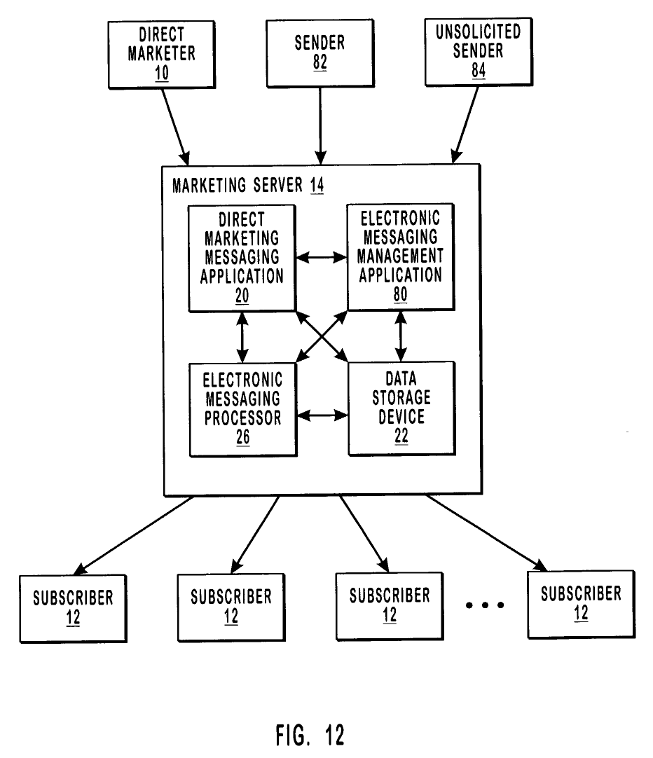

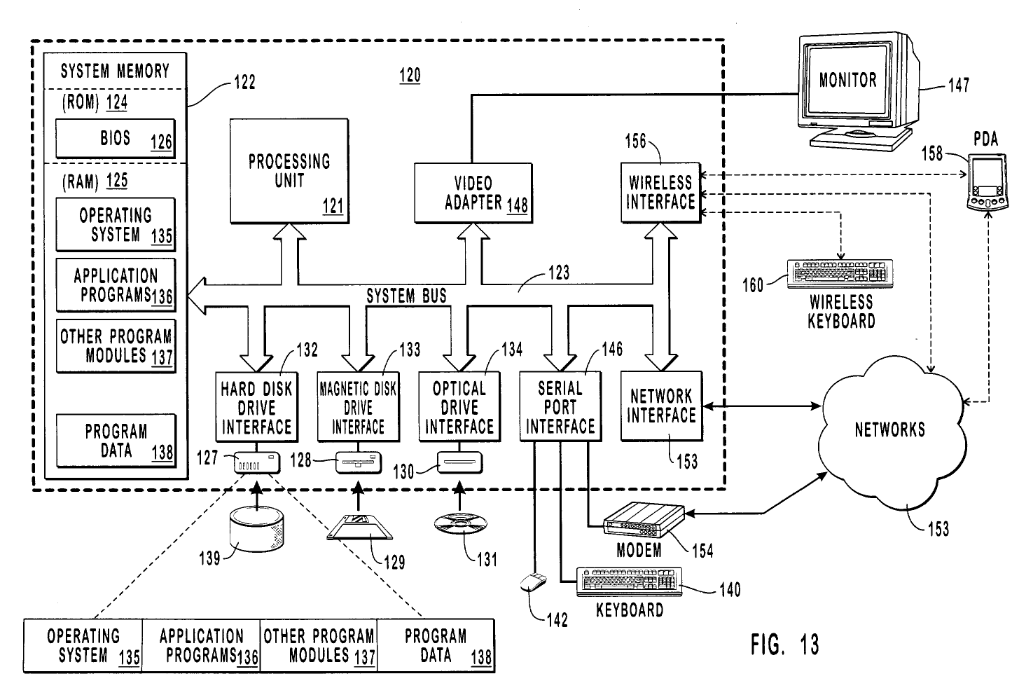

As mentioned before, direct marketing management application 20 may be used in conjunction with other applications. Depicted in FIG. 12 is one embodiment, where direct marketing management application 20 is used with an electronic message management application 80. Generally, electronic message management application 80 filters out unwanted or unsolicited electronic messages for subscribers. An application providing such functionality is described in U.S. patent application Ser. No. 10/174,561, entitled “Practical Methods for Reducing Unsolicited Electronic Messages by Identifying Sender's Addresses”, filed Jun. 18, 2002, which is incorporated herein by reference. In this embodiment, marketing server 14 comprises direct marketing management application 20, data storage device 22, electronic messaging processor 26, and electronic message management application 80, all of which interact with each other. It will be appreciated that electronic messaging processor 26 may be integrated as part of direct marketing management application 20 as described above. However, for purposes of this embodiment, electronic messaging processor 26 represents a standard electronic messaging processor that exists on marketer server 14.

As shown in FIG. 12, people or entities which try to transmit electronic messages to subscribers 12 may generally be classified as direct marketers 10, senders 82, or unsolicited senders 84. Direct marketers 10 are analogous to marketers 10 used above. Senders 82 indicates those people who may not be direct marketers but are permitted to send electronic messages to subscribers 12. Senders 82 may be relatives, colleagues, friends, and other wanted senders. Unsolicited senders 84 are those people or entities whose electronic message transmissions are undesired. These may include bulk e-mail solicitations, commercial solicitations, or other undesired solicitations. As discussed above, direct marketers 10 and undesired senders 84 differ due to the fact that direct marketers 10 are approved senders.

Electronic messaging management application 80 generally classifies sender's addresses into three categories: authorized, unauthorized, or unconfirmed. Those electronic messages with authorized sender's addresses are sent through to the subscriber's 12 inbox. Electronic messages with unauthorized or unconfirmed addresses are not allowed to transmit through to the subscriber's inbox. Direct marketing management application 20 thus modifies electronic messaging management application 80 by classifying direct marketer's 10 addresses as authorized. Alternatively, direct marketing management application 20 can modify only those direct marketers 12 which match up with each subscriber's 12 market survey 48 to be authorized. Direct marketing management application 20 and electronic messaging management application 80 thus work in combination to filter out unwanted electronic messages, but allow subscribers 12 to receive wanted electronic messages including desired direct marketing electronic messages. Moreover, subscribers' assent to receive direct marketing electronic messages as disclosed herein can provide such subscribers with free or reduced-cost access to the service of reducing or eliminating unwanted electronic messages.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

FIG. 13 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 13, an exemplary system for implementing the invention includes a general purpose computing device in the form of a conventional computer 120, including a processing unit 121, a system memory 122, and a system bus 123 that couples various system components including the system memory 122 to the processing unit 121. The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment generally indicated at 153 using logical connections to one or more remote computers as described above with reference to FIGS. 1B and 10-12. The logical connections referred to in FIG. 13 include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer 120 is connected to the local network through a network interface or adapter 153. When used in a WAN networking environment, the computer 120 may include a modem 154, a wireless link, or other means for establishing communications over the wide area network, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a computer system, a method for managing direct marketing for marketers on behalf of subscribers, comprising the acts of:
registering a plurality of marketers;
subscribing a plurality of subscribers who have consented to receiving marketing electronic messages;
obtaining marketing electronic messages associated with the marketers; and
sending the marketing electronic messages to one or more of the plurality of subscribers based on criteria that are used to determine which electronic messages are to be sent to the subscribers.

2. A method as recited in claim 1, wherein the act of subscribing comprises obtaining information specifying characteristics of the plurality of subscribers.

3. A method as recited in claim 1, wherein the act of registering comprises the act of receiving market profiles defining target demographics associated with marketing electronic messages of the marketers.

4. A method as recited in claim 1, further comprising the act of gathering marketing statistics relating to the marketing electronic messages received by said one or more of the plurality of subscribers.

5. A method as recited in claim 4, wherein the statistics relate to actions taken by subscribers with respect to received marketing electronic messages.

6. A method as recited in claim 5, wherein the statistics define the frequency by which the subscribers have responded to the received marketing electronic messages.

7. A method as recited in claim 6, further comprising the act of preventing a particular marketing electronic message from being sent again to subscribers if the frequency by which the subscribers respond to the particular marketing electronic message is less than a specified value.

8. A method as recited in claim 1, wherein the act of registering a plurality of marketers comprise the acts of:
providing information to a potential marketer regarding requirements for registration as an authorized marketer;
receiving a request for registration from the potential marketer; and
automatically registering the potential marketer as an authorized marketer upon the potential marketer fulfilling the requirements.

9. A method as recited in claim 8, wherein the requirements for registration are such that an indefinite number of marketers can meet the requirements for registration.

10. A method as recited in claim 8, wherein the requirements for registration are such that a only a limited number of marketers are permitted to be registered.

11. A method as recited in claim 1, wherein the act of registering a plurality of marketers is conducted such that only a specified limited number of marketers are permitted to be registered.

12. A method as recited in claim 11, wherein the specified limited number of marketers includes limitations of the number of marketers that market specified categories of goods or services.

13. A method as recited in claim 1, wherein the criteria include information specifying that a subscriber has requested not to receive marketing electronic messages from a particular marketer.

14. A method as recited in claim 1, wherein the criteria include geographic information specifying a location of the subscribers, such that locally relevant marketing electronic messages can be sent to the subscribers.

15. In a computer system, a method for managing direct marketing for marketers on behalf of subscribers, comprising the acts of:
registering a plurality of marketers;
subscribing a plurality of subscribers who have consented to receiving marketing electronic messages;
obtaining marketing electronic messages associated with the marketers;
monitoring the marketing electronic messages according to predetermined message criteria; and
sending the marketing electronic messages to one or more of the plurality of subscribers according to predetermined recipient criteria that define which subscribers are to receive which marketing electronic messages.

16. A method as recited in claim 15, wherein the predetermined message criteria define acceptable content of the marketing messages.

17. A method as recited in claim 15, wherein the predetermined message criteria define the frequency by which marketing electronic messages can be sent to subscribers.

18. A method as recited in claim 15, wherein the predetermined message criteria define the time at which the marketing electronic messages can be sent to subscribers.

19. A method as recited in claim 15, wherein the act of sending the marketing electronic messages is performed only after other electronic messages have been rejected for failure to comply with the predetermined message criteria.

20. A method as recited in claim 15, wherein the predetermined recipient criteria are selected using a market profile defining target demographics associated with the marketing electronic messages.

21. A method as recited in claim 15, wherein the predetermined recipient criteria are selected using market categories specifying characteristics of the subscribers.

22. A method as recited in claim 21, wherein the predetermined recipient criteria further are selected using a market profile defining target demographics associated with the marketing electronic messages such that marketing electronic messages are matched with subscribers.

23. A method as recited in claim 15, further comprising the act of filtering other incoming electronic messages addressed to at least one of the subscribers, wherein said other incoming electronic messages are filtered by determining whether sender's addresses contained in the incoming electronic messages correspond to senders that are unauthorized to send electronic messages to said at least one of the subscribers.

24. A method as recited in claim 15, wherein the acts of obtaining marketing electronic messages and sending the marketing electronic messages are conducted such that said one or more of the plurality of subscribers can remain anonymous from the standpoint of the marketers.

25. A method as recited in claim 15, further comprising the act of providing a report to one of the plurality of subscribers regarding the marketing activity of a particular one of the plurality of marketers.

26. In a computer system, a method for managing direct marketing for marketers on behalf of subscribers, comprising the acts of:
registering a plurality of marketers;
subscribing a plurality of subscribers who have consented to receiving marketing electronic messages;
obtaining marketing electronic messages associated with the marketers;
sending the marketing electronic messages to one or more of the plurality of subscribers;
gathering marketing statistics relating to actions taken by subscribers with respect to the marketing electronic messages received by the subscribers; and
determining, based on the marketing statistics, whether to send the marketing electronic messages again to subscribers.

27. A method as recited in claim 26, wherein the act of gathering marketing statistics comprises the act of receiving, at a server computer, information generated at client computers associated with the subscribers in response to the client computers monitoring the actions taken by the subscribers with respect to the marketing electronic messages.

28. A method as recited in claim 26, wherein the act of gathering marketing statistics comprises the act of monitoring, at a server computer, actions of the subscribers that are made in response to receiving the marketing electronic messages and are directed to the server computer.

29. A method as recited in claim 28, wherein the actions of the subscribers that are made in response to receiving the marketing electronic messages include the subscribers following a link in the marketing electronic messages that results in a request for information being directed to the server computer.

30. A method as recited in claim 26, wherein the actions of the subscribers comprise accessing the marketing electronic messages.

31. A method as recited in claim 26, wherein the actions of the subscribers comprise requesting information relating to the marketing electronic messages.

32. A method as recited in claim 26, wherein the actions of the subscribers comprise executing a transaction in response to a marketing electronic message.

33. A method as recited in claim 26, wherein the act of determining, based on the marketing statistics, whether to send the marketing electronic messages again to subscribers comprises the acts of:
determining that the frequency by which the subscribers respond to a particular marketing electronic message is less than a specified value; and
based on the act of determining, preventing the particular marketing electronic message from being sent again to subscribers.

34. In a computer system, a method for enabling marketers to engage in direct marketing to subscribers, comprising the acts of:
registering a plurality of marketers;
subscribing a plurality of subscribers who have consented to receiving marketing electronic messages; and
authorizing one or more of the plurality of marketers to send marketing electronic messages associated with said one ore more of the marketers by performing, for each of said one or more of the plurality of marketers, the acts of:
according to predefined recipient criteria that define which subscribers are to receive which marketing electronic messages, determining which of the subscribers are to receive the marketing electronic messages associated with the particular marketer; and
identifying to the particular marketer the subscribers that are to receive the marketing electronic messages associated with the particular marketer.

35. A method as recited in claim 34, further comprising the acts of:
gathering marketing statistics relating to actions taken by subscribers with respect to the marketing electronic messages received by the subscribers; and
determining, based on the marketing statistics, whether to enable the a particular marketer to send the marketing electronic messages again to subscribers.

36. A method as recited in claim 34, wherein the predetermined recipient criteria are selected using a market profile defining target demographics associated with the marketing electronic messages.

37. A method as recited in claim 34, wherein the predetermined recipient criteria are selected using market categories specifying characteristics of the subscribers.

38. A method as recited in claim 37, wherein the predetermined recipient criteria further are selected using a market profile defining target demographics associated with the marketing electronic messages such that marketing electronic messages are matched with subscribers.

39. In a computer system, a method for managing direct marketing for marketers on behalf of subscribers such that the subscribers can remain anonymous from the standpoint of the marketers, comprising the acts of:
obtaining marketing electronic messages associated with a plurality of marketers that are authorized to provide marketing electronic messages to subscribers; and
sending the marketing electronic messages to subscribers who have consented to receiving marketing electronic messages, the marketing electronic messages being sent to the subscribers based on criteria that define which electronic messages are to be sent to the subscribers, the marketing electronic messages being sent such that the subscribers can maintain anonymity from the standpoint of the marketers.

40. A method as recited in claim 39, further comprising the act of mediating communication from one of the subscribers to one of the plurality of marketers in response to said one of the subscribers having received a marketing electronic message from said one of the plurality of marketers, the communication being mediated such that said one of the subscribers can maintain anonymity from the standpoint of said one of the plurality of marketers.

41. A method as recited in claim 40, wherein the mediated communication is associated with a purchase of goods or services of said one of the plurality of marketers.

42. A method as recited in claim 40, wherein the act of mediating communication comprises the act of assigning to said one of the subscribers an ad hoc e-mail address that permits said one of the subscribers and said one of the plurality of marketers to communicate without said one of the subscribers losing anonymity.

43. A method as recited in claim 39, further comprising the acts of:
determining, by the computer system, that one of the subscribers has begun a process of engaging in communication that can result in potential loss of anonymity of said one of the subscribers; and
alerting said one of the subscribers to the potential loss of anonymity.

44. In a computer system, a method for managing direct marketing for marketers on behalf of subscribers, comprising the acts of:
registering marketers that are authorized to send marketing electronic messages to subscribers who have consented to receive marketing electronic messages, the marketers having agreed to regulation of their marketing electronic messages;
monitoring the marketing activity of the registered marketers; and
based on the monitoring of the marketing activity of the registered marketers, determining future marketing privileges of the registered marketers.

45. A method as recited in claim 44, wherein the act of determining future marketing privileges comprises the act of determining whether a particular registered marketer can continue to send marketing electronic messages to the subscribers.

46. A method as recited in claim 44, wherein the act of monitoring the marketing activity comprise the act of monitoring the actions of subscribers in response to receiving marketing electronic messages from the registered marketers.

47. A method as recited in claim 46, wherein the act of monitoring the actions of subscribers comprises the act of determining whether the actions of the subscribers in response to receiving the marketing electronic messages from a particular registered marketer are such that the marketing electronic messages are designated as being unwanted electronic messages, in which case the future marketing privileges of the particular registered marketer are reduced.

48. A method as recited in claim 44, wherein the act of monitoring the marketing activity comprises the act of generating a rating of a particular registered marketer, the rating defining the future marketing privileges of the particular registered marketer.

49. A method as recited in claim 48, wherein the act of generating a rating is performed in response to feedback received from subscribers.

50. A method as recited in claim 49, wherein the feedback comprises numerical rating information generated by the subscribers.

51. A method as recited in claim 49, wherein the feedback comprises complaints from the subscribers in response to the marketing activity of the particular registered subscriber.

52. A method as recited in claim 49, wherein the feedback is obtained by monitoring the actions of the subscribers made in response to receiving marketing electronic messages from the particular subscriber.

53. A method as recited in claim 44, wherein the act of determining future marketing privileges of the registered marketers comprises the act of automatically suspending marketing privileges of a particular registered marketer in response to monitoring the marketing activity of the particular registered marketer.

54. A method as recited in claim 44, wherein the act of determining future marketing privileges of the registered marketers comprises the act of placing a particular registered marketer on probation with a manual review process.

55. A method as recited in claim 44, further comprising the acts of:
permitting a particular registered marketer to initiate a new marketing campaign that begins with marketing electronic messages being sent to a limited number of subscribers;
monitoring actions made by the limited number of subscribers in response to receiving the marketing electronic messages so as to measure the effectiveness of the new marketing campaign; and
in response to the act of monitoring actions, determining whether the particular registered marketer is to be permitted to continue the new marketing campaign by sending marketing electronic messages to a larger number of subscribers.

56. A method as recited in claim 44, further comprising the act of providing a report to a particular registered marketer regarding the effectiveness of marketing electronic messages of the particular registered marketer.
